(19) United States
(12) Patent Application Publication
(10) Pub. No.: US 2013/0155147 A1
(43) Pub. Date: Jun. 20, 2013

(54) REDUCING CONDENSATION ACCUMULATION IN PRINTING SYSTEMS

(71) Applicants: Borden H. Mills, III, Webster, NY (US); Thomas A. Henderson, Rochester, NY (US); James H. Hurst, Rochester, NY (US); John L. Hryhorenko, Webster, NY (US)

(72) Inventors: Borden H. Mills, III, Webster, NY (US); Thomas A. Henderson, Rochester, NY (US); James H. Hurst, Rochester, NY (US); John L. Hryhorenko, Webster, NY (US)

(21) Appl. No.: 13/326,421

(22) Filed: Dec. 15, 2011

(51) Int. Cl. B41J 2/165

(52) U.S. Cl. 347/33

(57) ABSTRACT

A printing system includes a printing system component and a wick assembly affixed to the printing system component. The wick assembly includes at least one textile pad for collecting condensation that forms on a surface of the printing system component. A heater for heating the wick assembly can be disposed within, adjacent to, or in contact with the wick assembly.

### CROSS-REFERENCE TO RELATED APPLICATION

This patent application is related to U.S. patent application Ser No. ______ (Docket K000452), entitled “REDUCING CONDENSATION ACCUMULATION IN PRINTING SYSTEMS” filed concurrently herewith.

### TECHNICAL FIELD

The present invention relates to printing systems, and more particularly to reducing condensation accumulation in the printing systems.

### BACKGROUND

In a digitally controlled printing system, a print media is directed through a series of components. The print media can be a cut sheet or a continuous web. A web or cut sheet transport system physically moves the print media through the printing system. As the print media moves through the printing system, liquid, for example, ink, is applied to the print media by one or more printheads. This is commonly referred to as jetting of the liquid.

Multiple printheads are located in groups known as lineheads and each linehead can apply a different color or type of liquid. Dryers are located between selected lineheads to dry the applied liquids and avoid mixing of the liquids on the print media. These dryers increase the evaporation of moisture from the applied liquid, and also increase the temperature of the print media. As the temperature of the print media is increased, evaporation increases as more liquid is applied by subsequent lineheads in the narrow clearance gap between the printhead and the print media. In addition, although the dryers remove some of the moisture from the surface of the print media by applying a vacuum as the print media passes under the dryer, some moisture remains adjacent to the surface of the print media. The physical movement of the print media through the printing system then draws the warm humid air through the printing system.

The printheads are typically located and aligned by a support structure. If the support structure is at a lower temperature than the dew point of warm humid air in the clearance gap, condensation can accumulate on the surface of the support structure adjacent to the print media. Condensation that sufficiently accumulates can drip or otherwise touch the print media and adversely affect print quality. The drips spread the liquid or are visible as marks on the print media.

### SUMMARY

According to one aspect, a printing system includes a linehead having one or more printheads. The printhead or printheads are aligned by a support structure. A wick assembly can be affixed to the support structure, where the wick assembly includes at least one textile pad for collecting condensation that forms on a surface of the support structure. A heater for heating the wick assembly can be disposed within, adjacent to, or in contact with the wick assembly.

According to another aspect, a printing system includes a printing system component and a wick assembly affixed to the printing system component. The wick assembly includes at least one textile pad for collecting condensation that forms on a surface of the printing system component. A heater for heating the wick assembly can be disposed within, adjacent to, or in contact with the wick assembly.

According to another aspect, the printing system can include a hydrophilic coating disposed over the surface of the support structure or the printing system component.

According to another aspect, a printing system includes a linehead having one or more printheads. The printhead or printheads are aligned by a support structure. A wick assembly can be affixed to the support structure, where the wick assembly includes at least one textile pad for collecting condensation that forms on a surface of the support structure. A hydrophilic coating can be disposed over the surface of the support structure.

According to another aspect, a printing system includes a printing system component and a wick assembly affixed to the printing system component. The wick assembly includes at least one textile pad for collecting condensation that forms on a surface of the printing system component. A hydrophilic coating can be disposed over the surface of the printing system component.

### BRIEF DESCRIPTION OF THE DRAWINGS

In the detailed description of the example embodiments of the invention presented below, reference is made to the accompanying drawings, in which:

FIG. 1 is a schematic side view of a digital printing system for continuous web printing on a print media in an embodiment in accordance with the invention;

FIG. 2 is a schematic side view of components in a portion of the digital printing system, showing increased condensation regions in an embodiment in accordance with the invention;

FIG. 3 is a graphical illustration of a support structure face that is adjacent to the print media, with printheads aligned in a staggered formation in an embodiment in accordance with the invention;

FIG. 4 is a side view of a portion of support structure 30 and a first wick assembly in an embodiment in accordance with the invention;

FIG. 5 is a side view of a portion of support structure 30 and a second wick assembly in an embodiment in accordance with the invention;

FIG. 6 is a schematic side view of a portion of a digital printing system in one embodiment in accordance with the invention;

FIG. 7 is a side view of a portion of support structure 30 and a fourth wick assembly in an embodiment in accordance with the invention;

FIG. 8 is a side view of a portion of support structure 30 and a fourth wick assembly in an embodiment in accordance with the invention; and

FIG. 9 is a side view of a portion of support structure 30 and a fifth wick assembly in an embodiment in accordance with the invention.

### DETAILED DESCRIPTION

The present description will be directed in particular to elements forming part of, or cooperating more directly with, an apparatus in accordance with the present invention. It is to be understood that elements not specifically shown, labeled, or described can take various forms well known to those skilled in the art. In the following description and drawings, identical reference numerals have been used, where possible, to designate identical elements. It is to be understood that elements and components can be referred to in singular or plural form, as appropriate, without limiting the scope of the invention.

The example embodiments of the present invention are illustrated schematically and not to scale for the sake of clarity. One of ordinary skill in the art will be able to readily determine the specific size and interconnections of the elements of the example embodiments of the present invention.

As described herein, the example embodiments of the present invention provide a printhead or printhead components typically used in inkjet printing systems. However, many other applications are emerging which use inkjet printheads to emit liquids (other than inks) that need to be finely metered and deposited with high spatial precision. Such liquids include inks, both water based and solvent based, that include one or more dyes or pigments. These liquids also include various substrate coatings and treatments, various medicinal materials, and functional materials useful for forming, for example, various circuitry components or structural components. As such, as described herein, the terms “liquid” and “ink” refer to any material that is ejected by the printhead or printhead components described below.

Inkjet printing is commonly used for printing on paper. However, there are numerous other materials in which inkjet is appropriate. For example, vinyl sheets, plastic sheets, textiles, paperboard, and corrugated cardboard can comprise the print media. Additionally, although the term inkjet is often used to describe the printing process, the term jetting is also appropriate wherever ink or other liquids is applied in a consistent, metered fashion, particularly if the desired result is a thin layer or coating.

Inkjet printing is a non-contact application of an ink to a print media. Typically, one of two types of ink jetting mechanisms are used and are categorized by technology as either drop on demand ink jet (DOD) or continuous ink jet (CIJ). The first technology, “drop-on-demand” (DOD) ink jet printing, provides ink drops that impact upon a recording surface using a pressurization actuator, for example, a thermal, piezoelectric, or electrostatic actuator. One commonly practiced drop-on-demand technology uses thermal actuation to eject ink drops from a nozzle. A heater, located at or near the nozzle, heats the ink sufficiently to boil, forming a vapor bubble that creates enough internal pressure to eject an ink drop. This form of inkjet is commonly termed “thermal ink jet (TIJ).”

The second technology commonly referred to as “continuous” ink jet (CIJ) printing, uses a pressurized ink source to produce a continuous liquid jet stream of ink by forcing ink, under pressure, through a nozzle. The stream of ink is perturbed using a drop forming mechanism such that the liquid jet breaks up into drops of ink in a predictable manner. One continuous printing technology uses thermal stimulation of the liquid jet with a heater to form drops that eventually become print drops and non-print drops. Printing occurs by selectively deflecting one of the print drops and the non-print drops and catching the non-print drops. Various approaches for selectively deflecting drops have been developed including electrostatic deflection, air deflection, and thermal deflection.

In the above described technologies, drop size is a function of ink viscosity, which is affected by ink temperature. Thus, the temperature of the ink introduced into the ink jetting mechanisms must be controlled within certain temperature limits in some printing systems.

Additionally, there are typically two types of print media used with inkjet printing systems. The first type is commonly referred to as a continuous web while the second type is commonly referred to as a cut sheet(s). The continuous web of print media refers to a continuous strip of media, generally originating from a source roll. The continuous web of print media is moved relative to the inkjet printing system components via a web transport system, which typically include drive rollers, web guide rollers, and web tension sensors. Cut sheets refer to individual sheets of print media that are moved relative to the inkjet printing system components via rollers and drive wheels or via a conveyor belt system that is routed through the inkjet printing system.

The invention described herein is applicable to both types of printing technologies. As such, the term printhead, as used herein, is intended to be generic and not specific to either technology. Additionally, the invention described herein is applicable to both types of print media. As such, the term print media, as used herein, is intended to be generic and not as specific to either type of print media or the way in which the print media is moved through the printing system.

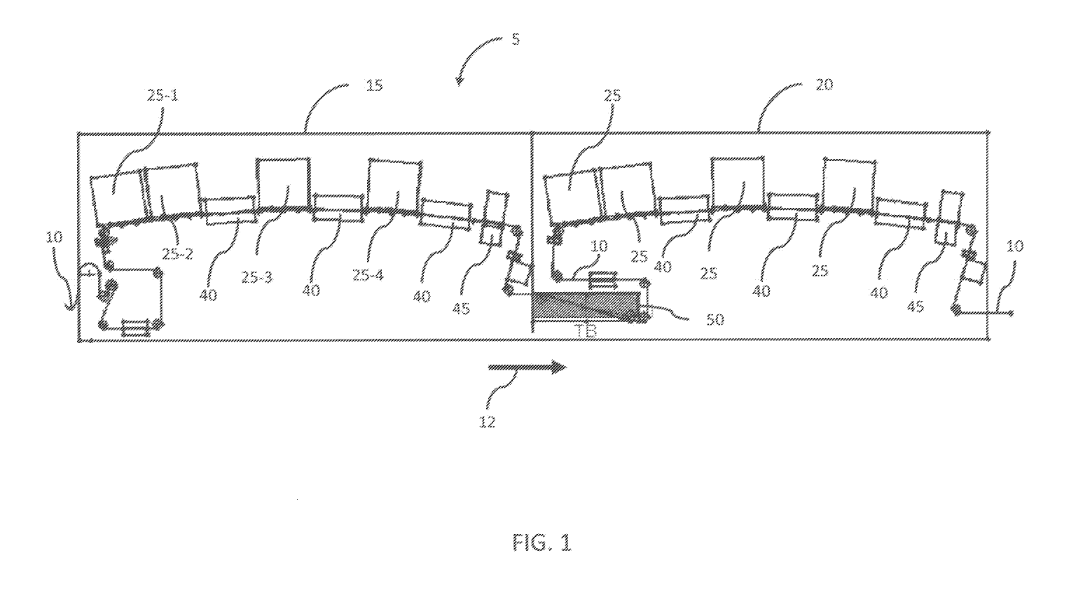

The terms “upstream” and “downstream” are terms of art referring to relative positions along the transport path of the print media; points on the transport path move from upstream to downstream. In FIGS. 1 through 9, the media moves from left to right as indicated by feed direction arrow 12. Where they are used, terms such as “first”, “second”, and so on, do not necessarily denote any ordinal or priority relation, but are simply used to more clearly distinguish one element from another.

Referring now to FIG. 1, there is shown a printing system 5 for continuous web printing on a print media 10. The printing system 5 includes a first module 15 and a second module 20, each of which includes lineheads 25, dryers 40, and a quality control sensor 45. Although FIG. 1 depicts each module with four lineheads 25, three dryers 40, and one quality control sensor 45, embodiments in accordance with the invention are not limited to this construction. A printing system can include any number of lineheads, any number of dryers, and any number of quality control sensors.

In addition, the first module 15 and the second module 20 include a web tension system (not shown) that serves to physically move the print media 10 through the digital printing system 5 in the feed direction 12 (left to right as shown in the figure). The print media 10 enters the first module 15 from the source roll (not shown). The linehead(s) 25 of the first module applies ink to one side of the print media 10. As the print media 10 feeds into the second module 20, there is a turnover mechanism 50 which inverts the print media 10 so that linehead(s) 25 of the second module 20 can apply ink to the other side of the print media 10. The print media 10 then exits the second module 20 and is collected by a print media receiving unit (not shown). For descriptive purposes only, the lineheads 25 are labeled a first linehead 25-1, a second linehead 25-2, a third linehead 25-3, and a fourth linehead 25-4.

In the illustrated embodiment, the lineheads 25 and dryers 40 are positioned to form an arc in order to maintain the tautness of the print media 10 underneath the lineheads. This causes the lineheads to be positioned at various angles, so that the first linehead 25-1 is angled so the print media 10 is travelling “uphill”, while the second linehead 25-2 is less so, the third linehead 25-3 is nearly level, and the last linehead 25-4 is angled so that the print media 10 is travelling “downhill”. Since the temperature of the print media increases throughout the alternate printing and drying processes, the linehead most likely to generate condensation is the last linehead 25-4, which is angled so that the condensate flows towards the downstream edge of the linehead, at which point the condensate can fall off or drip onto the print media 10.

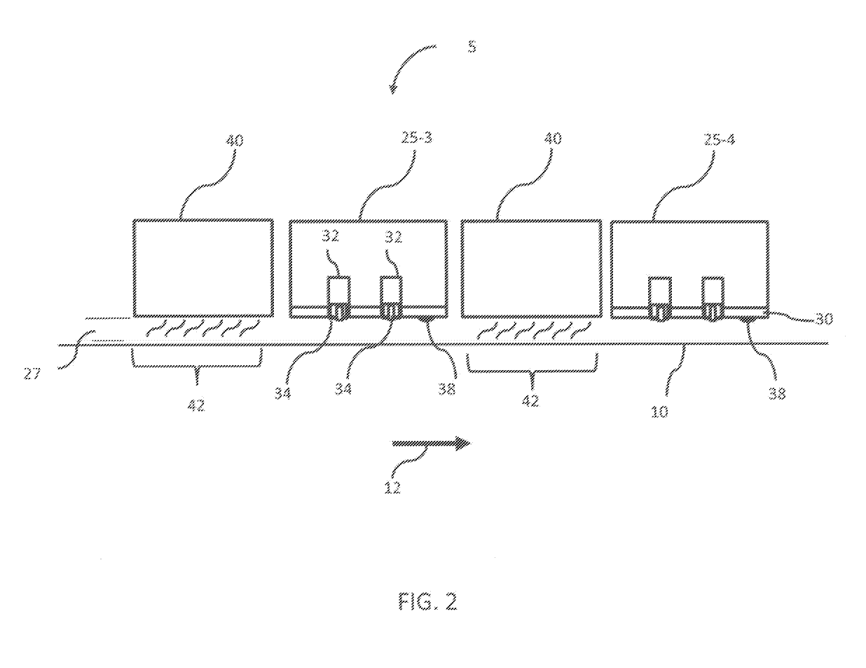

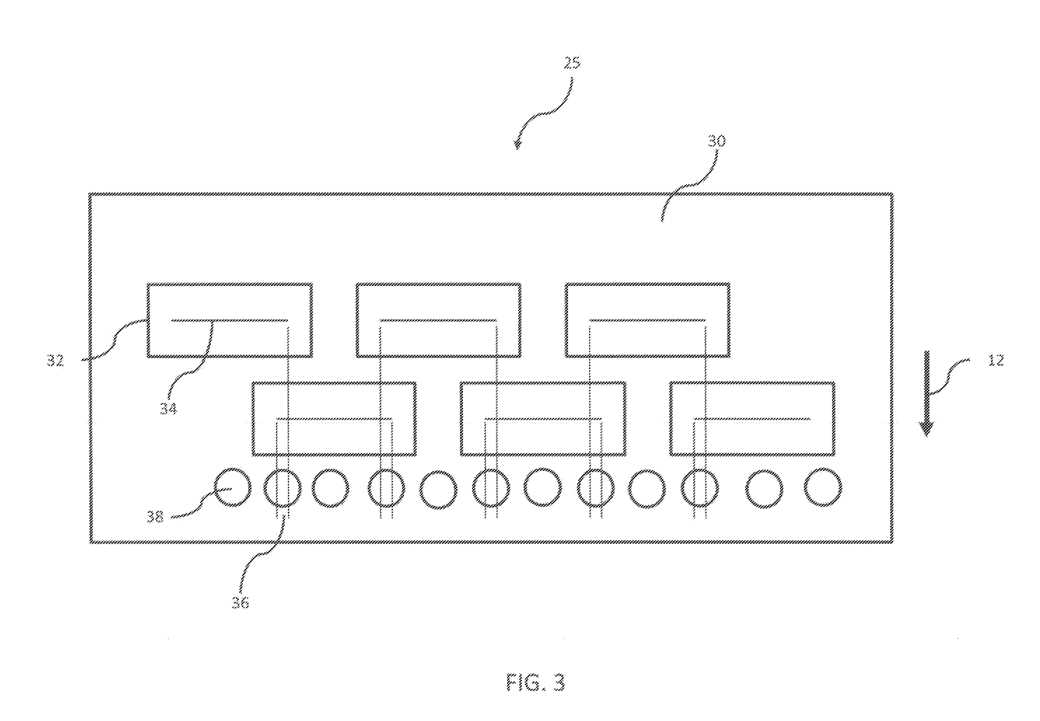

FIG. 2 illustrates a portion of the printing system 5 in more detail. As the print media 10 is directed through the printing system 5, the lineheads 25, which typically include a plurality of printheads 32, apply ink or another liquid, via the nozzle arrays 34 of the printheads 32. The printheads 32 within the linehead 25 are located and aligned by a support structure 30. (One such arrangement of printheads 32 in the linehead 25 is shown in FIG. 3.)

In one embodiment, the support structure 30 is very rigid and thus high in thermal mass to maintain an accurate relationship between the positions of the printheads. As the ink applied to the print media 10 dries by evaporation, the humidity of the air above the print media 10 rises in the clearance gap 27 between the printer components (for example, lineheads 25 and dryers 40) and the print media 10. To maintain accuracy of each jet of ink coming from each printhead, the clearance gap 27 is small and precisely controlled in the illustrated embodiment. To simplify the description, terms such as moisture, humid, humidity, and dew point that in a proper sense relate only to water in either a liquid or gaseous form, are used to refer to the corresponding liquid or gaseous phases of the solvents that make up a large portion of the inks and other coating fluids applied by the printheads 32. When the ink or other coating fluid is based on a solvent other than water, these terms are intended to refer to the liquid and gaseous forms of such solvents in a corresponding manner.

As the print media 10 moves in the feed direction 12 (left to right as shown in FIGS. 1 and 2), each dryer 40 emits heat 42 that increases the temperature of the print media 10. As the temperature of the print media 10 increases, the rate of evaporation of the liquid applied by each linehead also increases. In addition, as the print media 10 moves through each dryer 40, some of the moisture evaporated by the dryer is dragged along or entrained by the moving print media 10, even though a vacuum is drawn in the dryers to remove the moisture. As a result, a convective current develops and causes the warm humid air to flow downstream. When this happens, the warm humid air in the clearance gap 27 often comes into contact with downstream components of the printing system 5 in increasing amounts, such as, for example, the third linehead 25-3, and more particularly, the support structure 30 of the third linehead 25-3, and to an even greater extent, the support structure of the fourth linehead 25-4.

If the temperature of the support structure 30 is below the dew point of the warm humid air in the clearance gap 27, moisture condenses out of the humid air onto the support structure 30 of the lineheads. As ink is continually being printed on the print media 10, which then passes through the dryers 40 to dry the ink on the print media 10, moisture is continually being added to the air in the clearance gap 27. This continuous supply of moist air often leads to large amounts of moisture condensing on downstream components of the printing system 5. Typically, there is an increased condensation region 38 on the downstream portion of the support structure 30 (also shown in FIG. 3). Additionally, the print media 10 remains at an increased temperature after leaving the dryer 40 causing the ink to continue to evaporate, thereby adding moisture into the clearance gap 27. As such, the condensation issue is further amplified on lineheads 25 downstream of the dryer 40.

As the ink drops are jetted from nozzles of the nozzle array 34 either to the drop selection hardware or the print media 10, some of the solvent, water or otherwise, can evaporate moisture into the clearance gap 27. In continuous inkjet printers in particular, due to their continuous formation of streams of drops, this can add significant amounts of moisture to the air along the length of the nozzle array 34 even when nothing is being printed by the printhead 32. Solvent can also evaporate creating significant amounts of moisture during printing, especially during heavy coverage printing, in both continuous inkjet and drop-on-demand printing systems.

Referring now to FIG. 3, a face of the support structure 30 that is adjacent to the print media 10 and separated by the clearance gap 27 is shown. The printheads 32 are aligned in a staggered formation, with upstream and downstream printheads 32, such that the nozzle arrays 34 produce overlap regions 36. The overlap regions 36 enable the print from overlapped printheads 32 to be stitched together without a visible seam through the use of appropriate stitching algorithms that are known in the art. These stitching algorithms ensure that the amount of ink printed in the overlap region 36 is not higher than other portions of the print.

Other embodiments in accordance with the invention can include any number of printheads 32. Additionally, the printheads 32 can be arranged differently from the arrangement shown in FIG. 3.

Condensation is a relatively simple mechanism and can be reduced using several methods. For example, reducing the amount of condensable liquid can reduce condensation, but is critical to the basic performance of the jetting device. As a further example, decreasing the temperature of the print media can reduce condensation, but would also reduce the level of drying. As a still further example, increasing the gap between the lineheads and the print media can reduce condensation, but would also negatively affect image quality, due to increased distance for liquid deflection. Even further, decreasing the mass of the support structure can reduce condensation, but would reduce the accuracy of location of each printhead. As a result, embodiments in accordance with the invention reduce the effect of condensation by removing the condensation from the support structure 30 before the condensation can form drops and contaminate the print media.

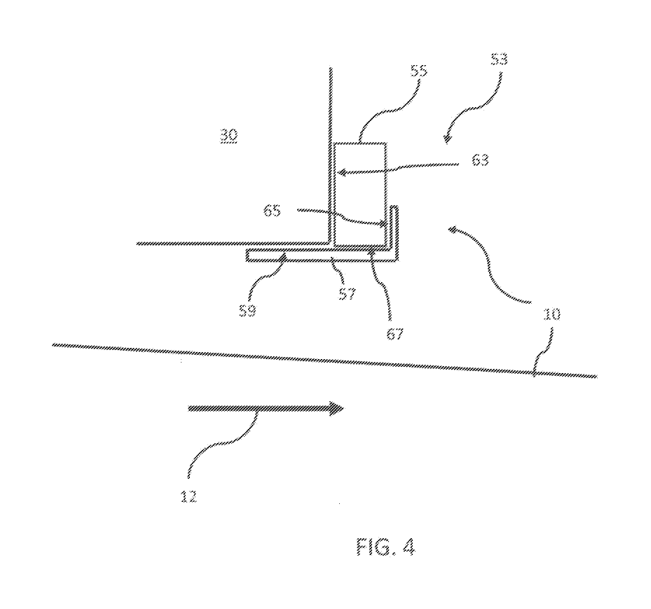

FIG. 4 is a side view of a portion of support structure 30 and a first wick assembly in an embodiment in accordance with the invention. Wick assembly 53 attaches to a downstream corner of the support structure 30 in one embodiment in accordance with the invention, and removes some or all of the accumulating condensation from the surface of the support structure 30.

Wick assembly 53 includes first textile pad 55 surrounded on two sides by second textile pad 57. In the illustrated embodiment, surface 59 of second textile pad 57 attaches to a portion of the downstream surface of the support structure adjacent to the print media 10 and surface 63 of first textile pad 55 attaches to the vertical surface of the support structure 30. Surfaces 65 and 67 of second textile pad 57 attach to first textile pad 55. Typically, condensation is more likely to accumulate and build up in certain regions of the support structure 30, such as towards the downstream side of the support structure 30 compared to the upstream side of the support structure 30. In one embodiment in accordance with the invention, wick assembly 53 extends across the support structure 30 in the cross-track direction (i.e., across the width of the print media).

First textile pad 55 can attach permanently or removably to the support structure 30 using any attachment material, including, but not limited to, adhesive or magnetic materials. First textile pad 55 is made of an absorbent material capable of storing condensation. By way of example only, first textile pad 55 is comprised of needled polyester fibers.

Second textile pad 57 transports the condensation away from the surface of the support structure 30 adjacent to the print media 10 to first textile pad 55. Second textile pad 57 is made with a material capable of transporting condensate by means of capillary pressure in an embodiment in accordance with the invention. First textile pad 55 collects the condensation until evaporation removes the collected condensation from first textile pad 55. Textile pads 55 and 57 can attach to each other by several methods, including, but not limited to, a perforated adhesive sheet (not shown) or by needling the fibers of second textile pad 57 into first textile pad 55.

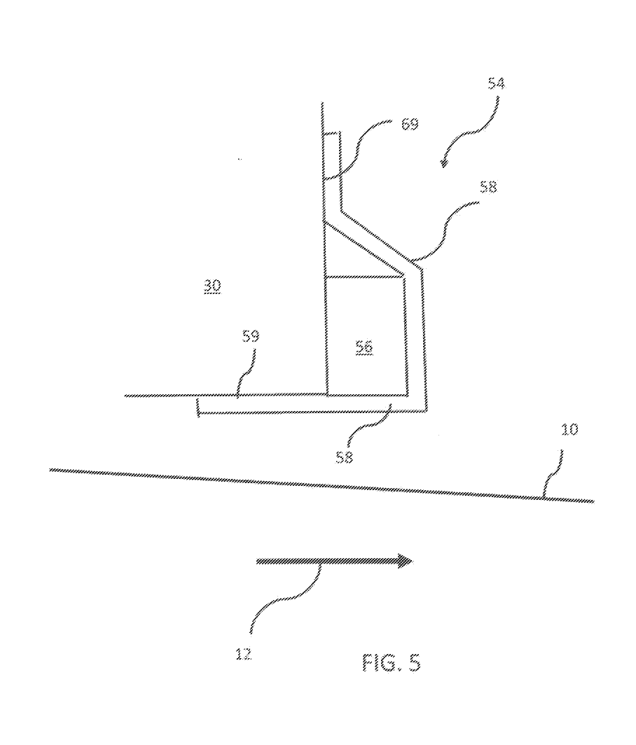

In another embodiment shown in FIG. 5, second wick assembly 54 is configured differently with second textile pad 58 removably attached to the support structure 30 at surface 59 and surface 69. Second textile pad 58 is in direct contact with first textile pad 56, but is not attached to first textile pad 56, allowing the second textile pad 58 to be replaced with a new textile pad when desired or needed.

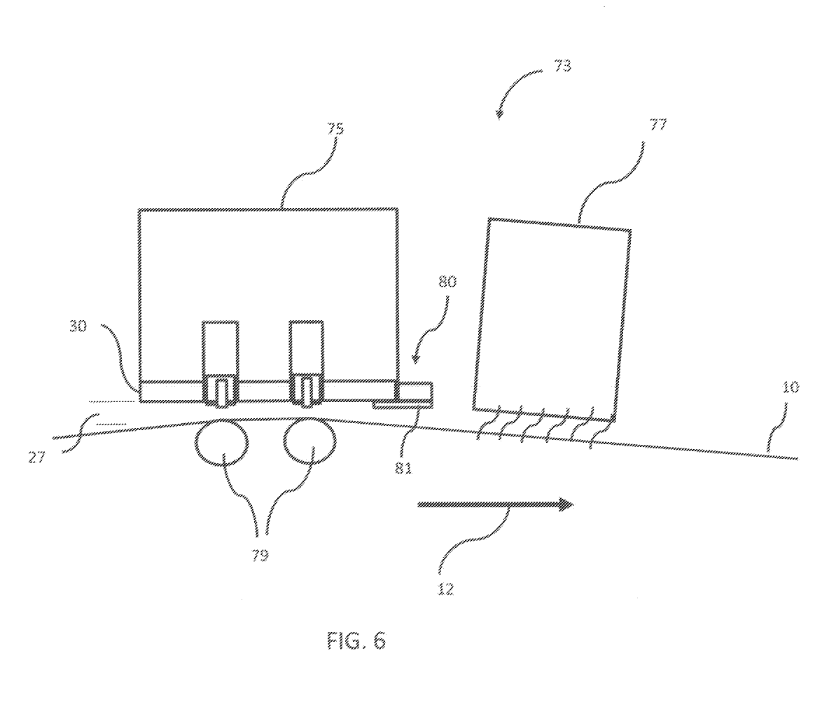

Referring now to FIG. 6, there is shown a schematic side view of a portion of a printing system in one embodiment in accordance with the invention. Printing system 73 includes linehead 75 and dryer 77. Digital printing system 73 is similar to the printing system 5 shown in FIG. 1, in that the lineheads 75 and dryers 77 are positioned to form an arc in order to maintain the tautness of the print media 10 underneath the lineheads. Linehead 75, for example, can be positioned in the location of linehead 25-4 in FIG. 1. FIG. 6 shows that the clearance gap 27 increases towards the downstream edge of linehead 75, by virtue of the relative angles of the linehead 75 and the dryer 77. In the illustrated embodiment, the print media transport rollers 79 are located directly opposite the printheads to insure the accuracy of the clearance gap 27. Since the print media 10 is angled downward on the downstream side of support structure 30, the space available for wick assembly 80 is greater and the risk of contact between the print media and second textile pad 81 reduced.

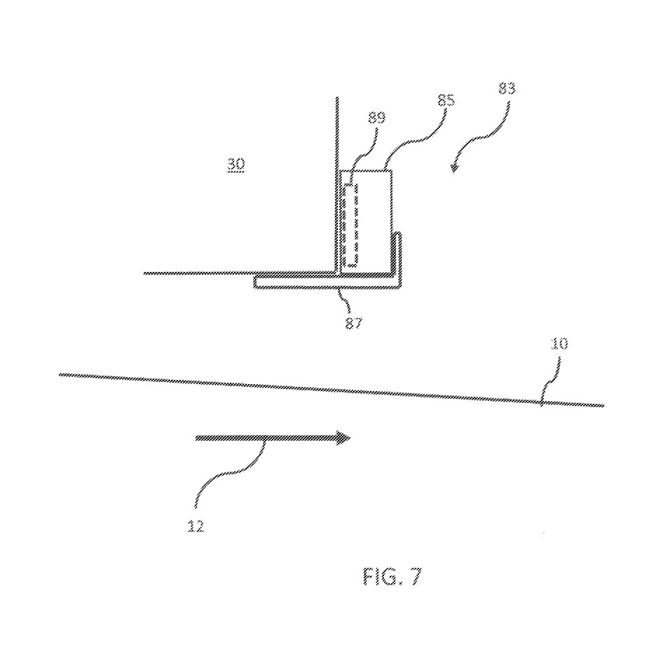

FIG. 7 is a side view of a portion of support structure 30 and a third wick assembly in an embodiment in accordance with the invention. Wick assembly 83 includes heater 89 and first textile pad 85 surrounded on two sides by second textile pad 87. Heater 89 can be disposed within, adjacent to, or in contact with the wick assembly 83. In the illustrated embodiment, heater 89 is within first textile pad 85. Heater 89 increases the evaporation rate of the collected condensation. Further, heater 89 can also be positioned to heat the support structure 30 as well as the wick assembly 83. Heating both the support structure 30 and wick assembly 83 further reduces condensation on the support structure 30 while increasing the evaporation rate of the collected condensation.

One example of a heater suitable for use in an embodiment in accordance with the invention is an insulated flexible heater. The flexible heater includes a resistive conductor disposed between two layers of polyimide film and provided with electrical leads. The resulting sheet-shaped heater can be adhered to a flat surface. Heat is generated when an electric current is passed through the leads to the conductor.

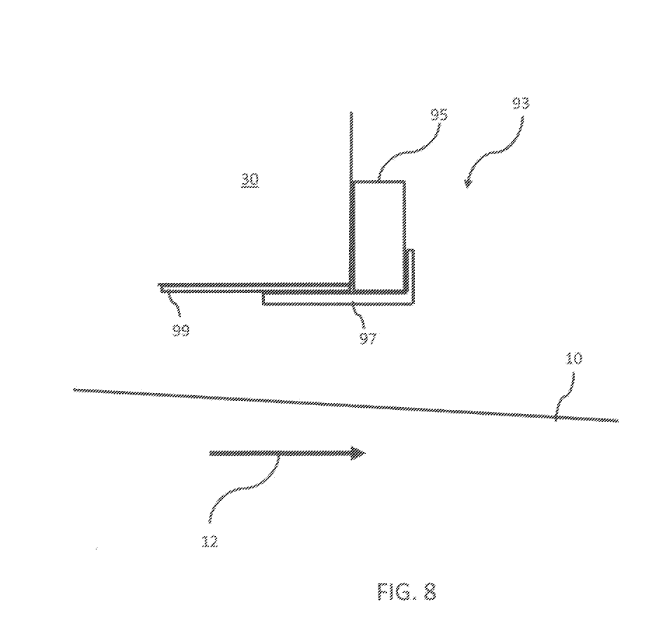

Referring now to FIG. 8, there is shown a side view of a portion of support structure 30 and a fourth wick assembly in an embodiment in accordance with the invention. Wick assembly 93 includes first textile pad 95 surrounded on two sides by second textile pad 97. A h_{y}drophilic coating 99 is formed over, and in contact with, the face of the support structure 30 that is adjacent to the print media 10. The hydrophilic coating 99 inhibits drop formation on the surface of the support structure 30. The hydrophilic coating 99 can be formed over the entire face of the support structure 30, or over one or more portions of the support structure 30.

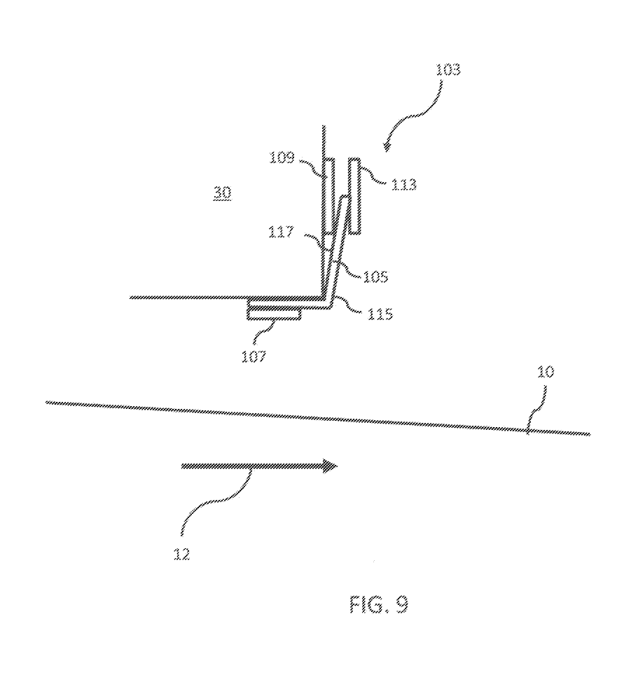

FIG. 9 is a side view of a portion of support structure 30 and a fifth wick assembly in an embodiment in accordance with the invention. Wick assembly 103 includes first textile pad 105 and fasteners 107, 109, 113. Fastener 107 is used to affix the first textile pad 105 to the face of the support structure 30 that is adjacent to the print media 10. Fasteners 109, 113 are used to affix the other end of the first textile pad 105 to support structure 30. Fasteners 107, 109, 113 can be implemented with any fastening material, including, but not limited to, adhesive and magnetic materials.

First textile pad 105 transports condensation away from the surface of the support structure 30 adjacent to the print media 10 by means of capillary pressure in an embodiment in accordance with the invention. First textile pad 105 is exposed to air along the exterior surface 115 of the first textile pad 105 as well as along a portion of the interior surface 117 of the textile pad. Exposing a larger surface area of the first textile pad 105 to air assists in evaporation of collected condensate.

Embodiments in accordance with the invention can include a wick assembly on any number of lineheads in a printing system. By way of example only, a wick assembly can be included on every linehead in a printing system, or on select lineheads that are more prone to condensation accumulation. In alternative embodiments, the wick assembly can be used with other types of printing system components that interact with the print media as the print media is transported past them. These components include, for example, image quality sensors, image registration sensors, color sensors, ink or media coating curing systems such as UV sources, web tension devices, web guiding structures such as rollers and turnover mechanisms, and combinations thereof.

The invention has been described in detail with particular reference to certain embodiments thereof, but it will be understood that variations and modifications can be effected within the spirit and scope of the invention. By way of example only, the lineheads, dryers and other components in the printing system do not have to be positioned to form an arc. The print media does not have to travel uphill or downhill in other embodiments in accordance with the invention.

And even though specific embodiments of the invention have been described herein, it should be noted that the application is not limited to these embodiments. In particular, any features described with respect to one embodiment may also be used in other embodiments, where compatible. And the features of the different embodiments may be exchanged, where compatible. By way of example only, the configuration of the second textile pad 58 shown in FIG. 5 can be used in the embodiment shown in FIG. 7-9. Additionally, embodiments in accordance with the invention can include a wick assembly, a heater, or a hydrophilic coating in various combinations or individually.
1. A printing system includes a linehead having one or more printheads. The printhead or printheads are aligned by a support structure. A wick assembly can be affixed to the support structure, where the wick assembly includes at least one textile pad for collecting condensation that forms on a surface of the support structure.
2. A printing system includes a linehead having one or more printheads. The printhead or printheads are aligned by a support structure. A heater can be affixed to the support structure.
3. A printing system includes a linehead having one or more printheads. The printhead or printheads are aligned by a support structure. A hydrophilic coating can be disposed over a surface of the support structure. The surface of the support structure can be the surface that is adjacent to the print media.
4. A printing system includes a linehead having one or more printheads. The printhead or printheads are aligned by a support structure. A wick assembly can be affixed to the support structure, where the wick assembly includes at least one textile pad for collecting condensation that forms on a surface of the support structure. A heater for heating the wick assembly can be disposed within, adjacent to, or in contact with the wick assembly.
5. The printing system in clause 4 can further include a hydrophilic coating disposed over the surface of the support structure. The surface of the support structure can be the surface that is adjacent to the print media.
6. The printing system as in clause 4 or clause 5, where the heater is contained within the wick assembly.
7. The printing system as in any one of clauses 4 through 6, where the wick assembly includes a first textile pad surrounded on two sides by a second textile pad.
8. The printing system as in any one of clauses 4 through 6, where the wick assembly includes a first textile pad.
9. The printing system as in clause 8, where the first textile pad is held in place between two fasteners on at least one side of the support structure such that the first textile pad is exposed to air along an exterior surface of the first textile pad and a portion of an interior surface of the first textile pad.
10. The printing system as in any one of clauses 4 through 9, where the wick assembly is removably attached to the support structure.
11. A printing system includes a linehead having one or more printheads. The printhead or printheads are aligned by a support structure. A wick assembly can be affixed to the support structure, where the wick assembly includes at least one textile pad for collecting condensation that forms on a surface of the support structure. A hydrophilic coating can be disposed over the surface of the support structure. The surface of the support structure can be the surface that is adjacent to the print media.
12. The printing system as in clause 11, where the wick assembly includes a first textile pad surrounded on two sides by a second textile pad.
13. The printing system as in clause 11, where the wick assembly includes a first textile pad.
14. The printing system as in clause 13, where the first textile pad is held in place between two fasteners on at least one side of the support structure such that the first textile pad is exposed to air along an exterior surface of the first textile pad and a portion of an interior surface of the first textile pad.
15. The printing system as in any one of clauses 11 through 14, where the wick assembly is removably attached to the support structure.
16. A printing system includes a linehead having one or more printheads. The printhead or printheads are aligned by a support structure. A wick assembly can be affixed to the support structure, where the wick assembly includes at least one textile pad for collecting condensation that forms on a surface of the support structure. A heater for heating the wick assembly can be disposed within, adjacent to, or in contact with the wick assembly. A hydrophilic coating can be disposed over the surface of the support structure.
17. The printing system as in clause 16, where the wick assembly includes a first textile pad surrounded on two sides by a second textile pad.
18. The printing system as in clause 16, where the wick assembly includes a first textile pad.
19. The printing system as in clause 18, where the first textile pad is held in place between two fasteners on at least one side of the support structure such that the first textile pad is exposed to air along an exterior surface of the first textile pad and a portion of an interior surface of the first textile pad.
20. The printing system as in any one of clauses 16 through 19, where the wick assembly is removably attached to the support structure.
21. The printing system as in any one of clauses 16-20, where the heater is contained within the wick assembly.
22. A printing system includes a printing system component and a wick assembly affixed to the printing system component. The wick assembly includes at least one textile pad for collecting condensation that forms on a surface of the printing system component. A hydrophilic coating can be disposed over the surface of the printing system component. The surface of the printing system component can be the surface that is adjacent to the print media.
23. The printing system as in clause 22, where the wick assembly includes a first textile pad surrounded on two sides by a second textile pad.
24. The printing system as in clause 22, where the wick assembly includes a first textile pad.
25. The printing system as in clause 24, where the first textile pad is held in place between two fasteners on at least one side of the printing system component such that the first textile pad is exposed to air along an exterior surface of the first textile pad and a portion of an interior surface of the first textile pad.
26. The printing system as in any one of clauses 22 through 25, where the wick assembly is removably attached to the printing system component.
27. A printing system includes a printing system component and a wick assembly affixed to the printing system component. The wick assembly includes at least one textile pad for collecting condensation that forms on a surface of the printing system component. A heater for heating the wick assembly can be disposed within, adjacent to, or in contact with the wick assembly.
28. The printing system in clause 27 can further include a hydrophilic coating disposed over the surface of the printing system component. The surface of the printing system component can be the surface that is adjacent to the print media.
29. The printing system as in clause 27 or clause 28, where the heater is contained within the wick assembly.
30. The printing system as in any one of clauses 27 through 29, where the wick assembly includes a first textile pad surrounded on two sides by a second textile pad.
31. The printing system as in any one of clauses 27 through 29, where the wick assembly includes a first textile pad.
32. The printing system as in clause 31, where the first textile pad is held in place between two fasteners on at least one side of the printing system component such that the first textile pad is exposed to air along an exterior surface of the first textile pad and a portion of an interior surface of the first textile pad.
33. The printing system as in any one of clauses 27 through 32, where the wick assembly is removably attached to the printing system component.

### PARTS LIST

5 printing system
10 print media
12 feed direction
15 first module
20 second module
25-1 linehead
25-2 linehead
25-3 linehead
25-4 linehead
27 clearance gap
30 support structure
32 printhead
34 nozzle array
36 overlap region
38 condensation region
40 dryer
42 heat
45 quality control sensor
50 turnover mechanism
53 wick assembly
54 wick assembly
55 textile pad
56 textile pad
57 textile pad
59 textile pad
59 surface
63 surface
65 surface
67 surface
69 surface
73 printing system
75 linehead
77 dryer
79 transport rollers
80 wick assembly
81 textile pad
83 wick assembly
85 textile pad
87 textile pad
89 heater
93 wick assembly
95 textile pad
97 textile pad
99 hydrophilic coating
103 wick assembly
105 textile pad
107 fastener
109 fastener
113 fastener
115 exterior surface
117 interior surface

1. A printing system, comprising:
a linehead comprising a plurality of printheads aligned by a support structure;
a wick assembly affixed to the support structure, wherein the wick assembly comprises at least one textile pad for collecting condensation that forms on a surface of the support structure; and
a heater for heating the wick assembly.

2. The printing system of claim 1, further comprising a hydrophilic coating disposed over the surface of the support structure.

3. The printing system of claim 1, wherein the heater is contained within the wick assembly.

4. The printing system of claim 1, wherein the wick assembly comprises a first textile pad surrounded on two sides by a second textile pad.

5. The printing system of claim 1, wherein the wick assembly comprises a first textile pad.

6. The printing system of claim 5, wherein the first textile pad is held in place between two fasteners on at least one side of the support structure such that the first textile pad is exposed to air along an exterior surface of the first textile pad and a portion of an interior surface of the first textile pad.

7. The printing system of claim 1, wherein the wick assembly is removably attached to the support structure.

8. A printing system, comprising:
a printing system component;
a wick assembly affixed to the printing system component, wherein the wick assembly comprises at least one textile pad for collecting condensation that forms on a surface of the printing system component; and
a heater for heating the wick assembly.

9. The printing system of claim 8, further comprising a hydrophilic coating disposed over the surface of the printing system component.

10. The printing system of claim 8, wherein the heater is contained within the wick assembly.

11. The printing system of claim 8, wherein the wick assembly comprises a first textile pad surrounded on two sides by a second textile pad.

12. The printing system of claim 8, wherein the wick assembly comprises a first textile pad.

13. The printing system of claim 12, wherein the first textile pad is held in place between two fasteners on at least one side of the printing system component such that the first textile pad is exposed to air along an exterior surface of the first textile pad and a portion of an interior surface of the first textile pad.

14. The printing system of claim 8, wherein the wick assembly is removably attached to the support structure.
